(19) United States
(12) Patent Application Publication
(10) Pub. No.: US 2007/0084373 A1
(43) Pub. Date: Apr. 19, 2007

(54) Method for imaging printing formes

(75) Inventors: Thomas Kothmayr, Munster (DE); Dirk Probian, Gablingen/Lutzelburg (DE); Udo Till, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/545,636

(22) Filed: Oct. 10, 2006

(30) Foreign Application Priority Data
Oct. 13, 2005 (DE) 10 2005 048 983.4

(51) Int. Cl. B41N 3/00

(52) U.S. Cl. 101/463.1

(57) ABSTRACT

The method for imaging a rewritable printing forme includes the following steps: providing the rewritable printing forme having a surface, applying an imaging material to the surface of the printing forme in order to provide a permanent and erasable image on the surface of the printing forme, and registering or recording the application of the imaging material and therefore a quality of an actual imaging, which is generated on the printing forme, on line relative to the application of the imaging material to the surface of the printing forme.

### BACKGROUND OF THE INVENTION

The invention relates to a method for imaging rewritable printing formes.

During printing with a printing forme, in principle a distinction is drawn between printing processes which in which a printing forme can be written once or printing processes with a rewritable printing forme. Printing processes which use rewritable printing formes are also referred to using the keyword “computer to press/direct imaging”. The present invention relates to a method for producing a permanent and erasable image on such a rewritable printing forme, that is to say a method for imaging rewritable printing formes.

Known digital printing presses marketed under the product description “DICOweb” operate with rewritable and erasable printing formes. During the production of a permanent and erasable image on such a rewritable printing forme, a basic printing forme cylinder is preferably subjected to an erasure step and an imaging step. Imaging of the printing forme is possibly followed by fixing and conditioning of the imaged printing forme. The basic principles of the DICOweb technology are known from “Handbuch der Printmedien” [Printing Media Manual], Helmut Kipphan, pages 674-680, 2000, Springer-Verlag.

It is already known from practice, following the application of the imaging material, and therefore in a manner decoupled from the imaging, to inspect imaged printing formes with a camera, to check the quality of the imaged printing plate.

A result of decoupling the imaging from the quality checking of the imaging is relatively long process times.

### SUMMARY OF THE INVENTION

Proceeding from this background, it is an object of the present invention to provide a novel method for imaging rewritable printing formes.

According to a preferred embodiment of the invention, the application of the imaging material and therefore a quality of an actual imaging is registered or recorded on line relative to the application of the imaging material to the surface of the printing forme.

As a result of parallelizing the imaging and the quality control of the imaging, process times can be reduced considerably.

According to a preferred development of the invention, a determined actual imaging of the printing forme is compared with an intended imaging, and then, if it is established during this comparison that the actual imaging of the printing forme in specific sections differs by more than permissible tolerances from the intended imaging, the printing forme is erased and re-imaged, at least in these sections.

Preferred developments of the invention emerge from the subclaims and the following description. An exemplary embodiment of the invention, without being restricted thereto, will be explained in more detail in the following text.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a flow diagram showing the steps according to an embodiment of the method of the present invention.

### DETAILED DESCRIPTION OF THE PRESENTLY PREFERRED EMBODIMENTS

The present invention relates to a method for producing a permanent and erasable image on the surface of a rewritable and erasable printing forme, the method preferably being carried out within a printing press. However, the method according to the invention can also be performed outside a printing press. The method according to the invention can be employed both in the case of rewritable printing plates and in the case of rewritable printing sleeves.

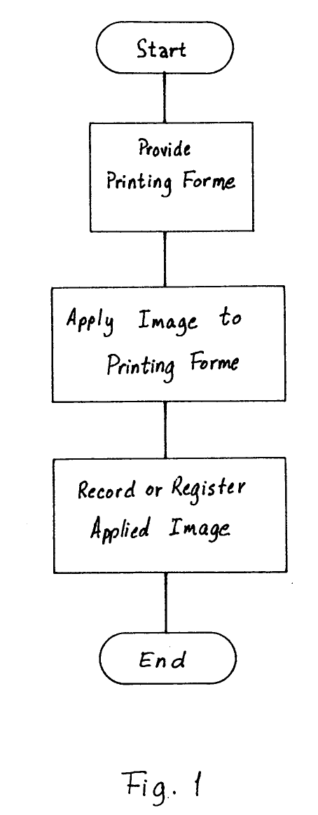

As shown in FIG. 1, to produce the printing forme with a permanent and erasable image, a printing forme is provided (step S1) and, if appropriate, previously subjected to an erasure step in the region of its surface, imaging of the surface of the printing forme being carried out after the erasure step by applying an imaging material, in particular a polymer-like imaging material, to the surface of the printing forme (step S2).

The application of the imaging material to the surface of the printing forme is preferably carried out with a thermal transfer process. It is also possible to spray the imaging material onto the surface of the printing forme or to apply it in another way.

According to a preferred embodiment of the present invention, it is proposed, to register or record the application of the imaging material and therefore the quality of the imaging on line during the application of the imaging material to the surface of the printing forme (step S3). For this purpose, the application of the imaging material and, respectively, the actual imaging of the printing forme that is formed during the application of the imaging material is registered or recorded with a sensor or a camera. The result of this registration or recording, namely the actual imaging that is formed, is compared with an intended imaging. The intended imaging of the printing forme is determined by image data, on the basis of which the application of the imaging material to the printing forme is carried out. The intended imaging is in this case preferably dependent on prepress data.

If, during the comparison between the actual imaging that is formed and the intended imaging, it is determined that the actual imaging of the printing forme in specific sections of the printing forme differs by more than permissible tolerances or threshold values from the intended imaging, it is also within the spirit of the present invention to erase and then re-image the printing forme at least in these sections. If, during the on-line quality control of the imaging, it is established that the actual imaging that is formed differs from the intended imaging, in the spirit of the present invention provision can be made for the imaging of the printing forme to be stopped immediately. Following the stoppage, depending on the deviation, either the printing forme imaged up to that point can be erased completely or it can be erased in the section in which the deviation between the actual imaging and the intended imaging has been determined.

The imaging and the on-line quality control of the imaging are preferably carried out in a traversing manner according to the present invention. For this purpose, an imaging device for applying the imaging material to the printing forme, and a sensor or camera for registering or recording the actual imaging that is formed during the imaging are arranged on a crossmember and, for the purpose of imaging and on-line quality control of the imaging, are moved in the axial direction in a traversing manner past a printing forme driven in rotation. This makes it possible to image a printing forme section by section and, during imaging, to register on line the actual imaging of the printing forme that is formed, and to evaluate it by comparison with the intended imaging.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for imaging a rewritable printing forme, comprising the steps of:
providing the rewritable printing forme having a surface;
applying an imaging material to the surface of the printing forme to provide a permanent and erasable image on the surface of the printing forme; and
registering or recording an actual imaging generated on the printing forme and a quality of the permanent and erasable image applied, said step of registering or recording being performed on line during the application of the imaging material to the printing forme.

2. The method of claim 1, wherein the step of registering or recording the application of the imaging material and the quality of the permanent and erasable image is performed with a sensor or a camera, and wherein the method further comprises the step of comparing the actual imaging resulting from the step of registering or recording with an intended imaging.

3. The method of claim 2, further comprising the step of erasing and re-imaging the printing forme at least in specific sections, if, during the step of comparing, it is determined that the actual imaging of the printing forme in these sections of the printing forme differs by more than permissible tolerances from the intended imaging.

4. The method of claim 2, further comprising the step of determining the intended imaging of the printing forme using image data used for the step of applying.

5. The method of claim 2, wherein the step of applying the imaging material to the surface of the printing forme and the step of registering or recording the actual imaging on the printing forme are carried out in a traversing manner by appropriate devices arranged on a crossmember being moved jointly and translationally in an axial direction past the rotating printing forme.
